(19) United States
(12) Patent Application Publication
(10) Pub. No.: US 2006/0216134 A1
(43) Pub. Date: Sep. 28, 2006

(54) Securing mechanism

(75) Inventors: Thomas A. Whorley, Mineral Springs, TX (US); Steve Tollefson, Mineral Wells, TX (US)

Correspondence Address: MILES & STOCKBRIDGE PC, 1751 PINNACLE DRIVE, SUITE 500, MCLEAN, VA, 22102-3833, US

(73) Assignee: Cantex, Inc., Mineral Wells, TX (US)

(21) Appl. No.: 11/086,236

(22) Filed: Mar. 23, 2005

(51) Int. Cl. F16B 37/16

(52) U.S. Cl. 411/437

(57) ABSTRACT

A clip cooperates with a fastener, such as a mounting screw, to hold the fastener securely in an object. The clip can be designed into the object or, for example, the objects designed to receive the clip. The construction of the clip not only allows an installer to “push” the fastener into the fastener-receiving hole a certain distance thereby obviating the need to screw all the threads to complete the installation, but also provides a greater holding force between the clip and the fastener, and thus the objects. The clip can also include one or more knife-edged tabs that engage the fastener.

### RELATED APPLICATION DATA

This application is related to copending Application Ser. No. 10/946,327 entitled “Quick Set Device For Mounting Electrical Devices,” filed on Sep. 22, 2004, which claims priority to U.S. Provisional Patent Application No. 60/504,203 entitled “Quick Set Device For Mounting Electrical Devices,” filed on Sep. 22, 2003, and U.S. Design Patent No. D,491,537, entitled “Quick Set Device For Mounting Electrical Devices,” issued on Jun. 15, 2004, all of which are incorporated herein by reference in their entirety.

### BACKGROUND

1. Field of the Invention

This invention generally relates to securing mechanisms. In particular, an exemplary embodiment of this invention relates to securing mechanisms having at least one knife-edged surface that engages a portion of a fastener to thereby hold the fastener securely.

2. Description of Related Art

Electrical work boxes are known that receive one or more screws that secure one or more of an electrical receptacle, such as an outlet, and a faceplate to the electrical work box. Typically these screws are screwed directly into the plastic of the work box. Due to the configuration of the receiving hole for these mounting screws, the user is required to turn the screw numerous times before the screw head becomes flush with the surface of the item being affixed to the work box and therefore tight.

### SUMMARY

Exemplary aspects of the present invention are directed toward a clip that cooperates with a fastener, such as a mounting screw, to hold the fastener securely in an object. For example, and in accordance with a first exemplary embodiment, the clip is associated with the object. The clip can be designed into the object or, for example, the object designed to receive the clip. The construction of the clip not only allows an installer to “push” the fastener into the fastener-receiving hole a certain distance thereby obviating the need to screw all the threads to complete the installation, but also provides a greater holding force between the clip and the fastener, and thus the object.

Another exemplary embodiment of the invention is directed toward a clip having a knife-edge on one or more engagement tabs that are associated with the clip. These engagement tabs contact the fastener, such as a mounting screw, thereby increasing the holding force there between.

In accordance with yet another exemplary embodiment, the clips can be made by running a ribbon of material through a stamp that partially cuts a portion of the clip out of the material. The partially stamped clip can remain affixed to the ribbon that is, for example, placed on the reel. The reel may then be fed into an assembly machine for inserting the clips into, for example, plastic electrical work boxes or the assembly machine can break the clip off of the ribbon. The ribbon, and thus the clip, can be made of, for example, pre-plated or non-corrosive material such as stainless steel, Beryllium-copper, zinc-coated, heat treated, or any other type of material as appropriate.

Another exemplary aspect of the invention relates to a clip that has a plurality of flexible engagement tabs that not only have a knife-edged nose, but also have a radius cut in the nose of the engagement tab wherein the radius can be designed, for example, to match a root diameter of a fastener.

These and other features and advantages of this invention are described in, or are apparent from, the following description of the embodiments.

### BRIEF DESCRIPTION OF THE DRAWINGS

The embodiments of the invention will be described in detail, with reference to the following figures, wherein:

FIG. 1 illustrates an environmental view of an exemplary clip mechanism according to this invention;

FIG. 2 illustrates a back-side perspective view of the exemplary clip mechanism according to this invention;

FIG. 3 illustrates a side view of the exemplary clip mechanism according to this invention;

FIG. 4 illustrates a bottom view of the exemplary clip mechanism according to this invention;

FIG. 5 illustrates a front-side view of the exemplary clip mechanism according to this invention;

FIG. 6 illustrates a back-side view of the exemplary clip mechanism according to this invention;

FIG. 7 illustrates a cross-sectional view of a screw partially engaged by the exemplary clip mechanism according to this invention;

FIG. 8 illustrates a screw fully engaged by the exemplary clip mechanism according to this invention;

FIG. 9 illustrates a second environmental view of an exemplary clip mechanism located in an electrical work box according to this invention;

FIG. 10 is an enlarged view of portion A in FIG. 9;

FIG. 11 is a hidden-line view illustrating the exemplary clip secured in an electrical work box according to this invention;

FIG. 12 is an enlarged view of portion B of FIG. 11;

FIG. 13 is an enlarged partial cross sectional view taken along plane A-A of FIG. 1 of the exemplary clip secured in an electrical work box according to this invention; and

FIG. 14 illustrates a partial cross-section of the clip taken along plane B-B of FIG. 1.

### DETAILED DESCRIPTION

The exemplary systems methods of this invention will be described in relation to a clip or securing mechanism. However, to avoid unnecessarily obscuring the present invention, the following description omits well-known structures and devices. For the purposes of explanation, numerous specific details are set forth in order to provide a thorough understanding of the present invention. It should be appreciated, however, that the present invention may be practiced in a variety of ways beyond these specific details. For example, the clip mechanism is not limited to use in an electrical work box or to the number of engagement tabs as shown. In general, the clip mechanism can be used in conjunction with any device or object to assist with the securing of a fastener thereto. Furthermore, the number of engagement tabs can be varied to include any number of engagement tabs, the engagement tabs can be cut at a radius at the nose end, as well as knife-edged, or any combination thereof.

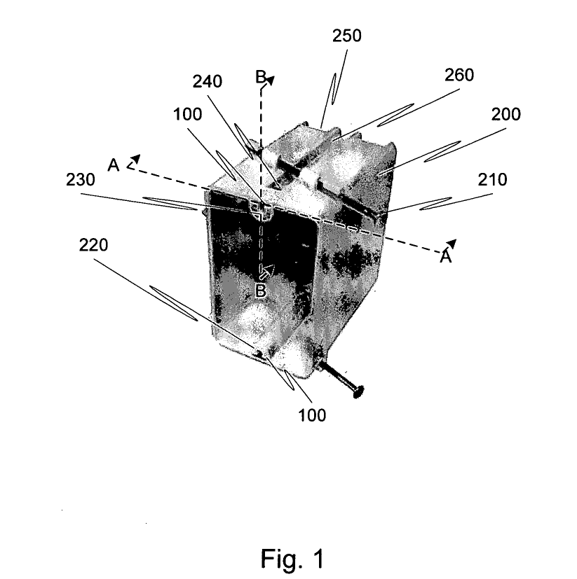

FIG. 1 illustrates an exemplary electrical work box 200. The exemplary electrical work box 200 comprises one or more fasteners, such as nails 210, for securing the electrical work box 200 to, for example, a stud (not shown), a first screw-receiving portion 220, a second screw-receiving portion 230, a lip 240 designed to hold the clip mechanisms 100 in the electrical work box 200, one or more punch-out portions 250, for receiving cable therethrough, and a trough 260 that allows, for example, longer screws to extend past the clip mechanism 100 adjacent to the electrical work box 200.

As illustrated in FIG. 1, a fastener, such as a threaded machine or sheet metal type screw, can be inserted into the screw-receiving portion 220. The screw-receiving portion 220 can be designed to be of slightly larger diameter than that of the screw, thereby holding the screw in contact with the clip mechanism 100. Through this cooperation between the clip mechanism 100 and the screw-receiving portion, the fastener is held firmly in place within the electrical work box 200.

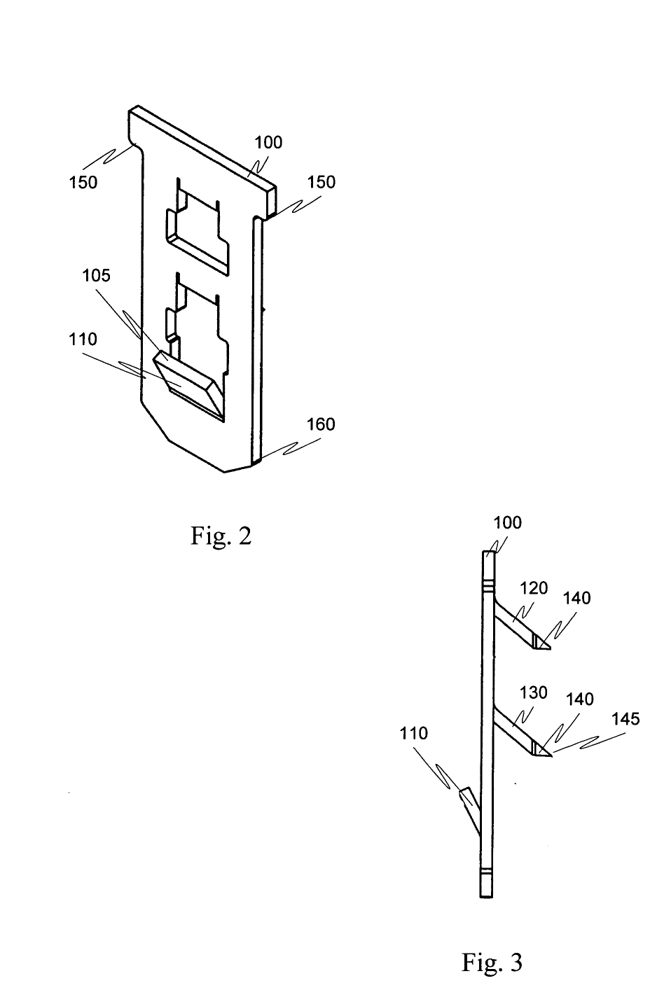

FIG. 2 illustrates the clip mechanism 100 from the backside or box engagement side. It should be appreciated that this backside not be limited to contacting an electrical box, but rather can come into contact and be modified as appropriate for cooperation with any structure to allow engagement and to provide the force opposing that of a fastener coming into contact with the engagement tab(s).

The securing mechanism 100 illustrated in FIG. 2 highlights the securing tab 110 extending at an angle of, for example, 90 degrees or less from the securing mechanism 100. The securing tab 110 has a securing tab engagement surface 105 that comes into contact with the structure into which the securing mechanism 100 is placed. The securing tab 110 can be made of a spring-like material such that depression of the securing tab 110 is possible so that it can be pressed flush with the securing mechanism 100 to a allow, for example, insertion of or withdrawal from the structure into which it is inserted.

The securing mechanism 100 also includes a bevel 160 that facilitates, for example, insertion of the securing mechanism 100 into a structure as well as a hip portion 150 that limits the insertion depth of the securing mechanism 100.

FIG. 3 illustrates a side view of the securing mechanism 100. In particular, one or more engagement tabs, such as engagement tabs 120 and 130, are on a first side of the securing mechanism 100, while the securing tab 110 is on the opposite side of the securing mechanism 100. It should be appreciated that the securing tab 110 could also be placed on the same side as the one or more engagement tabs with the corresponding configuration of the structure into which is inserted modified so as to hold the securing mechanism in place. The location of the securing tab 110 could also relocated to any position on the securing mechanism 100.

In this exemplary embodiment, the engagement tabs 120 and 130 also include a knife-edge portion 140 on the nose of the engagement tab that is “sharpened” to better engage the fastener. As discussed hereinafter, one or more of the noses of the engagement tabs in addition to, or in lieu of, being knife-edged, could also be cut on a radius at the tip end 145 to increase the contact area with a fastener.

As with the securing tab 110, the engagement tab(s) can also be flexible such that a ratcheting-type action is provided when a threaded fastener is inserted. This could allow, for example, a push-in-and-twist type motion for quickly securing a screw in a structure.

It should be appreciated that the securing tab engagement surface 105 could also be knife-edged and/or radiused based on, for example, the type of structure into which the securing mechanism is intended for use.

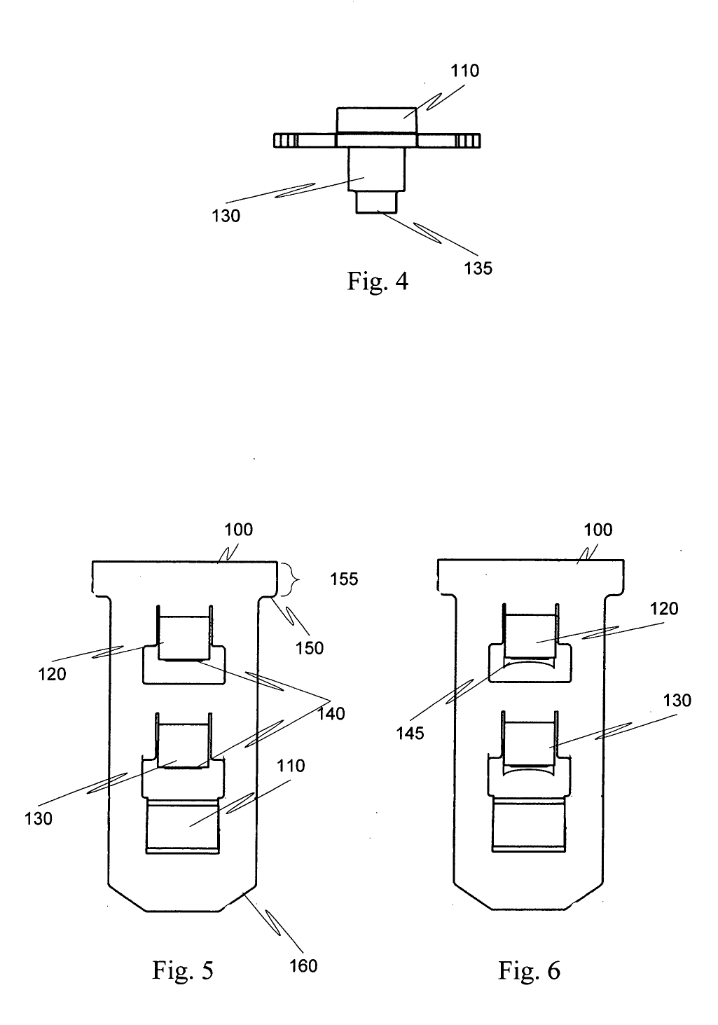

FIG. 4 illustrates a bottom view of the securing mechanism 100. In particular, the securing tab 110 is illustrated on the opposite side of the engagement tab 130. In this particular exemplary embodiment, the engagement tab 130 is tapered. It should be appreciated that the end 135 of the engagement tab 130 is not limited to being narrower than the base of the engagement tab 130, but could also be larger and, as previously discussed, knife-edged and/or radiused.

FIG. 5 illustrates a front-side view of the securing mechanism 100. In this view, the hip structure 150 and bevel 160 are clearly seen. The securing mechanism 100 also includes a head portion 155. As previously discussed, this head portion can be utilized, for example, to secure adjacent securing mechanisms to a ribbon or tape as well as allow, for example, as a surface that can be gripped to remove the securing mechanism 100 from a structure.

FIG. 6 illustrates an alternative embodiment of the securing mechanism 100 where one or more of the engagement tabs 120/130 have a radiused tip 145. The radiused tip(s) can be combined with the knife-edging as previously discussed. Furthermore, it should be appreciated that in the case where there is more than one engagement tab associated with the securing mechanism 100, the tips of each engagement tab can vary such that, for example, one engagement tab may be knife-edged, another engagement tab may be radiused, and a third engagement tab may be knife-edged and radiused. In general, any number of engagement tabs with any type of tip or combination of tip can be utilized in conjunction with the disclosed embodiments of this invention.

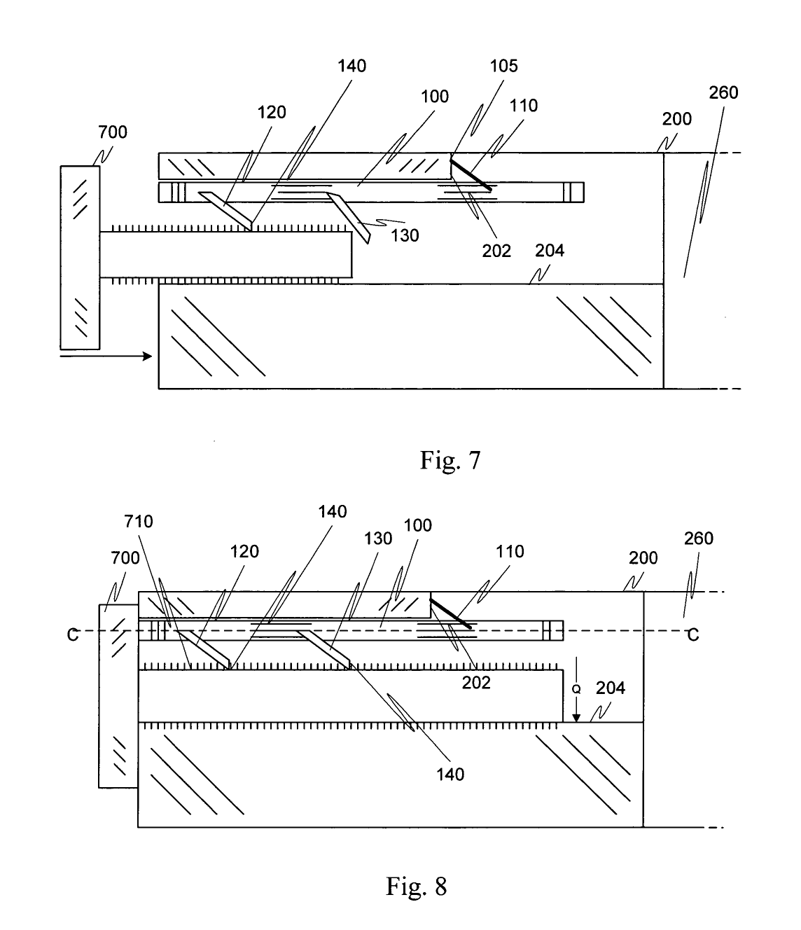

FIG. 7 is a cross-sectional view taken along plane B-B of FIG. 1. In particular, FIG. 7 illustrates an intermediate operational position of a screw 700 being inserted into a structure, which in this case is a portion of an electrical work box 200.

The securing mechanism 100 is illustrated in its installed position with the securing tab 110, and in particular the securing tab engagement surface 105 in contact with the work box securing mechanism engagement surface 202. As will be illustrated in greater detail hereinafter, the securing tab 110 cooperates with the hip structure 150 to firmly “lock” the securing mechanism 100 into a structure. This “locking” type operation can occur, for example, as a securing mechanism 100 is pressed into a structure and the securing tab 110 springs from an insertion position into a secured position as shown in FIG. 7.

In this partially inserted view, the screw 700 and, in particular, threads 710 are engaging the first engagement tab 120 and particularly the knife edge 140. As previously discussed, the securing mechanism 100 can be used in conjunction with a fastener to provide a push-in-and-turn type operation. Thus, in this intermediate state as illustrated in FIG. 7, the screw 700 and threads 710 slide across the work box fastener engagement surface 204 as the one or more engagement tabs, in this case engagement tab 120 deflects and comes into contact with the threaded surface of the screw 700.

FIG. 8 illustrates the screw 700 flush with and snug against the work box 200. After the screw 700 has been pushed in, the screw is turned in a tightening direction at which point the engagement tabs 120 and 130 create a force Q pushing the threaded portion 710 of the screw 700 into the work box fastener engagement surface 204. At the same time, the knife edges 140 of the engagement tabs 120 and 130 securely engage the thread 710 thereby holding the screw 700 firmly in the work box 200.

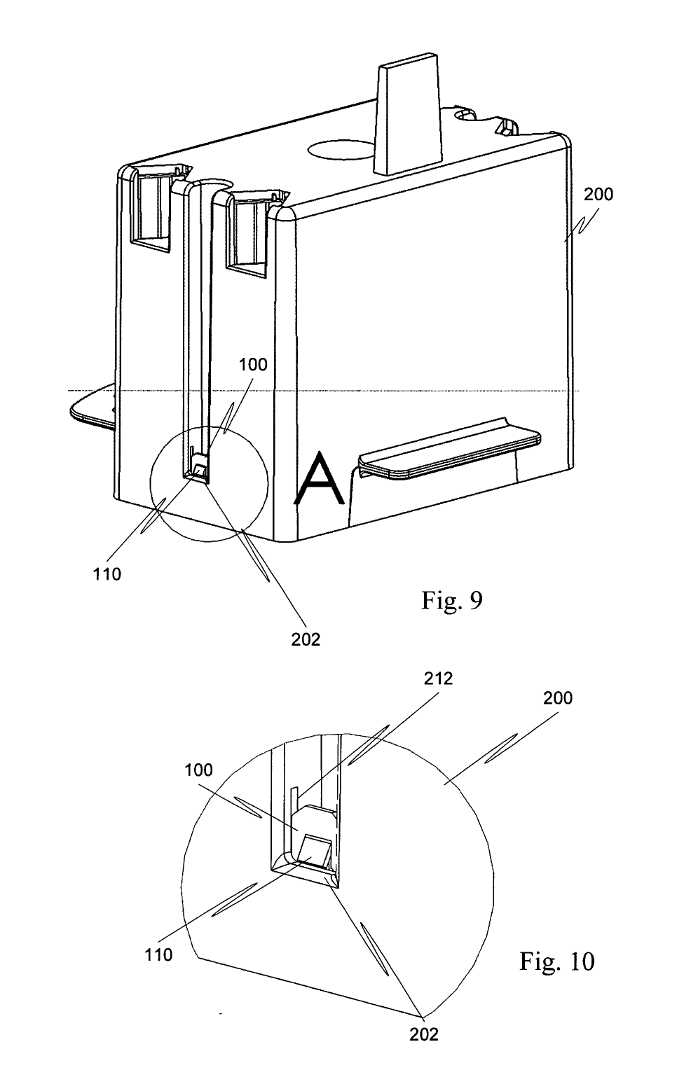

FIG. 9 illustrates an environmental perspective view of a work box 200 with the exemplary securing mechanism 100 installed therein. In this view, the securing tab 110 can be seen in contact with the work box securing mechanism engagement surface 202.

FIG. 10 is an enlarged view of portion A of FIG. 9. In greater detail, the securing mechanism 100 can be seen inserted into receiving slot 212(s) which thereby hold the securing mechanism 100 in the appropriate position relative to screw 700.

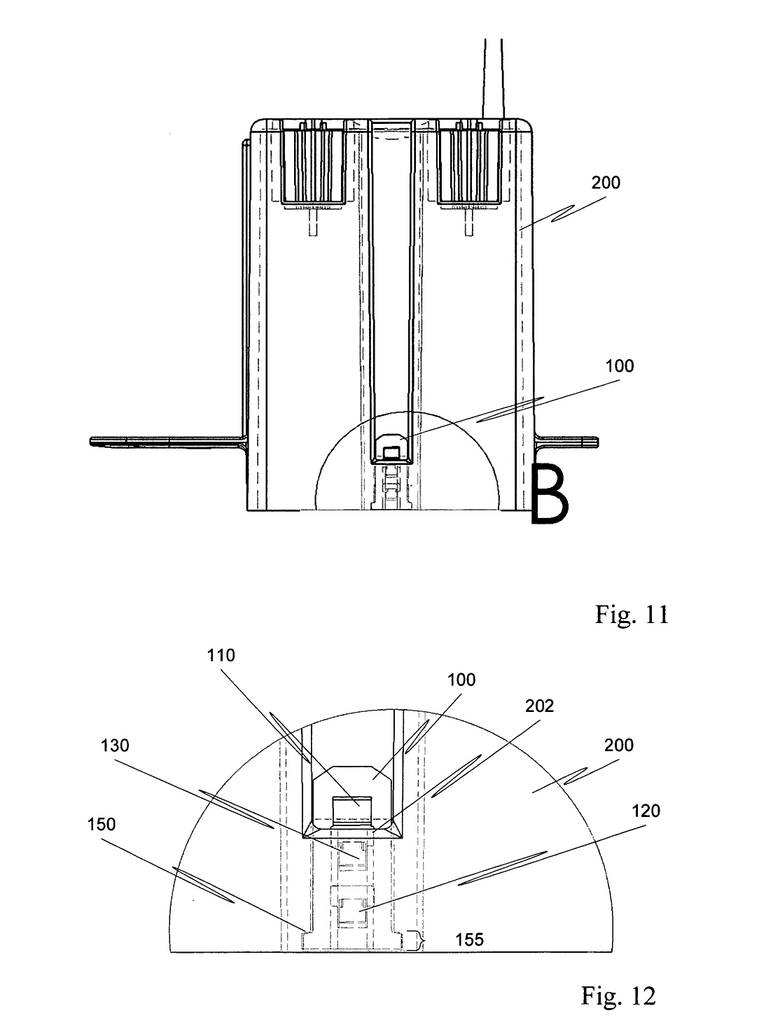

FIG. 11 illustrates a hidden-line view of the exemplary securing mechanism 100 installed in an electrical work box 200. In greater detail, FIG. 12 is an exploded view of portion B of FIG. 11. In this exploded view, the securing mechanism 100 is shown with a securing tab 110 abutting the work box securing mechanism engagement surface 202. Furthermore, the head portion 155 and hip structure 150 can be seen as being recessed into the work box 200. The work box is thus provided with a complementary structure adapted to receive the hip structure 150.

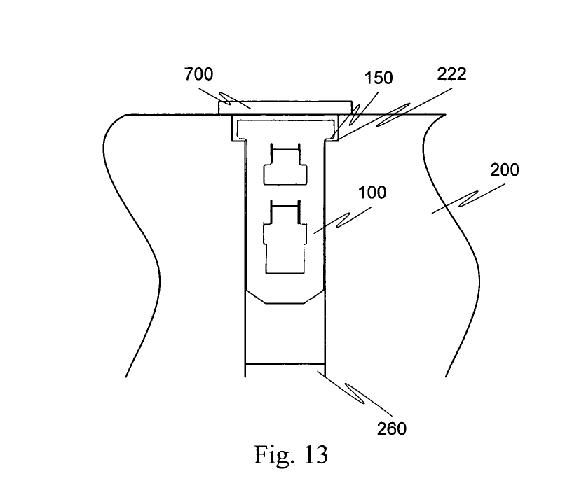

FIG. 13 is a cross-sectional view taken along plane C-C of FIG. 8. In particular, the securing mechanism 100 is illustrated with the hip structure 150 in contact with the hip engagement surface 222. As previously discussed, cooperation between the hip structure 150, hip engagement surface 222, work box securing mechanism engagement surface 202, and the securing tab 110 securely hold the securing mechanism 100 in the work box 200.

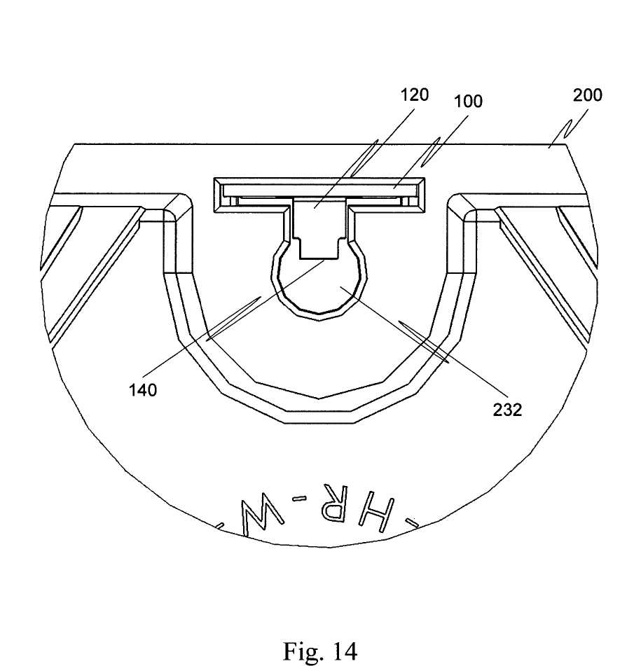

FIG. 14 illustrates an end view of the work box having an exemplary securing mechanism 100 installed therein. The engagement tab 120 extends into the hole 232 into which a fastener, such as a screw, is inserted. As the screw is inserted, the engagement tab 120 deflects with the knife-edge surface 140 ratcheting over the thread on the fastener thereby allowing the fastener to be pressed substantially into the work box 200. The screw can then be tightened with minimal turns thereby affixing the screw securely to the work box 200.

It is therefore apparent that there has been provided, in accordance with the present invention, a securing mechanism. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A securing mechanism configured to secure a fastener in an object comprising:
at least one securing tab extending from a fist surface of the securing mechanism;
at least one second tab on a surface of the securing mechanism opposite the at least one securing tab, at least one of the at least one second tab having a nose portion that is knife-edged; and
a hip structure configured to cooperate with the at least one first tab to secure the securing mechanism in the object.

2. The securing mechanism of claim 1, wherein the nose portion is also cut at a radius.

3. The securing mechanism of claim 1, wherein the object is an electrical workbox.

4. The securing mechanism of claim 1, further comprising a beveled portion.

5. The securing mechanism of claim 1, wherein the at least one second tab is flexible.

6. The securing mechanism of claim 1, wherein the securing mechanism is one or more of stainless steel, Beryllium-copper, zinc-coated and heat treated metal.

7. The securing mechanism of claim 1, wherein the nose portion of the at least one second tab engages the fastener.

8. The securing mechanism of claim 1, wherein the at least one second tab extends from the securing mechanism at an angle of less than 90°.

9. The securing mechanism of claim 1, wherein the securing mechanism slides into slots formed in the object.

10. The securing mechanism of claim 9, wherein the slots hold the securing mechanism at a fixed distance relative and parallel to the fastener.

11. The securing mechanism of claim 1, wherein the at least one securing tab engages a securing mechanism engagement surface on the object.

12. A securing mechanism configured to secure a fastener comprising:
at least one securing tab extending from a fist surface of the securing mechanism; and
at least one second tab extending from an opposite surface of the securing mechanism, at least one of the at least one second tab having a nose portion that is knife-edged.

13. The securing mechanism of claim 12, wherein the nose portion is also cut at a radius.

14. The securing mechanism of claim 12, further comprising a beveled portion at a first end of the securing mechanism.

15. The securing mechanism of claim 12, wherein the at least one second tab is flexible.

16. The securing mechanism of claim 12, wherein the securing mechanism is one or more of stainless steel, Beryllium-copper, zinc-coated and heat treated metal.

17. The securing mechanism of claim 12, wherein the nose portion of the at least one second tab engages the fastener.

18. The securing mechanism of claim 12, wherein the at least one second tab extends from the securing mechanism at an angle of less than 90°.

19. The securing mechanism of claim 12, wherein the nose portion is cut at a radius, the radius based on a diameter of the fastener.

20. A method of securing a fastener in an object comprising:
pushing the fastener into a fastener receiving portion, the fastener receiving portion having on one side a securing mechanism that includes:
at least one securing tab extending from a fist surface of the securing mechanism; and
at least one fastener engagement tab on a surface of the securing mechanism opposite the at least one securing tab, at least one of the at least one fastener engagement tab having a nose portion that is knife-edged; and
rotating the fastener in a tightening direction.

21. The method of claim 20, wherein during the pushing step, the at least one fastener engagement tab deflects to allow passage of fastener threads.
